(19) United States
(12) Patent Application Publication
(10) Pub. No.: US 2026/0163149 A1
(43) Pub. Date: Jun. 11, 2026

(54) TOUCH PADS FOR MODULES PROTECTION IN HIGH VOLTAGE BATTERY

(71) Applicant: FCA US LLC, Auburn Hills, MI (US)

(72) Inventors: Asim Qamar, Auburn Hills, MI (US); Wei Wei, Auburn Hills, MI (US); Krishnamurthy Hegde, Auburn Hills, MI (US)

(21) Appl. No.: 18/973,195

(22) Filed: Dec. 9, 2024

(51) Int. Cl. H01M 50/242; H01M 50/204; H01M 50/249; H01M 50/271

(52) U.S. Cl. CPC H01M 50/242; H01M 50/204; H01M 50/249; H01M 50/271

(57) ABSTRACT

A battery pack assembly for an electrified vehicle includes a main body assembly, a top cover and a first spacer. The main body assembly houses a plurality of battery modules therein, the plurality of battery modules having cell supervisory circuits. The top cover is coupled to the main body assembly, the top cover having an interior surface that faces the plurality of battery modules. The first spacer is disposed on the interior surface of the top cover and occupies a space generally between the top cover and at least one battery module of the plurality of battery modules. The first spacer is configured to engage a battery module of the plurality of battery modules during an impact event that deforms the top cover toward the battery modules.

### FIELD

The present application generally relates to electrified vehicles and, more particularly, to a high voltage battery pack assembly incorporating a plurality of spacers on an inside surface of the top cover that mitigate force transfer to critical components of the battery pack assembly such as cell supervisory circuits.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes a battery pack assembly that includes a housing that houses one or more battery modules or cells. Typically, the battery pack assembly includes a high voltage battery system generally includes a battery pack assembly that includes a housing that houses one or more battery packs. In some instances, impact loads experienced during an impact event can cause undesirable relative movements of components in a battery pack such as the top cover of the battery pack, frame members and cooling plates. Accordingly, while such conventional battery pack assemblies do work well for their intended purpose, there exists an opportunity for improvement in the relevant art.

### SUMMARY

According to one example aspect of the invention, a battery pack assembly for an electrified vehicle includes a main body assembly, a top cover and a first spacer. The main body assembly houses a plurality of battery modules therein, the plurality of battery modules having cell supervisory circuits. The top cover is coupled to the main body assembly, the top cover having an interior surface that faces the plurality of battery modules. The first spacer is disposed on the interior surface of the top cover and occupies a space generally between the top cover and at least one battery module of the plurality of battery modules. The first spacer is configured to engage a battery module of the plurality of battery modules during an impact event that deforms the top cover toward the battery modules.

In some implementations, the top cover comprises an outermost surface and a first inset, wherein the first inset is offset from the outermost surface toward a first battery module of the plurality of battery modules.

In some implementations, the first spacer is disposed at the first inset.

In some implementations, the first spacer is vertically aligned with the first battery module and a second battery module of the plurality of battery modules.

In some implementations, the first spacer is adhesively coupled to the top cover.

In other features, the first spacer is glued to the top cover.

In other implementations, the first spacer is formed of nylon.

In additional arrangements, the cell supervisory circuits comprise a first cell supervisory circuit associated with the first battery module and a second cell supervisory circuit associated with the second battery module.

In other examples, the first and second cell supervisory circuits are vertically aligned with the outermost surface of the top cover outside of the first inset.

In other features, the battery pack assembly further includes a second spacer disposed on the interior surface of the top cover and occupying a space generally between the top cover and at least one battery module of the plurality of battery modules.

In some implementations, the first and second spacers are both arranged on the first inset.

In examples, the battery pack assembly further includes a third spacer and a fourth spacer disposed on the interior surface of the top cover and occupying a space generally between the top cover and at least one battery module of the plurality of battery modules.

In additional features, the third and fourth spacers occupy a second inset provided on the top cover, distinct from the first inset.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

The present disclosure will become more fully understood from the detailed description and the accompanying drawings, given purely by way of non-limiting example, wherein:

FIG. 1 is a functional block diagram of an electrified vehicle having a battery system according to the principles of the present application;

FIG. 2 is top perspective view of a high voltage battery pack assembly of the battery system of FIG. 1 according to the principles of the present application;

FIG. 3 is a top view of the battery pack assembly of FIG. 2 according to the principles of the present application;

FIG. 4 is a bottom view of a top cover of the battery pack assembly of FIG. 2 according to the principles of the present application; and

FIG. 5 is a sectional view taken along lines 5-5 of the battery pack assembly of FIG. 2 according to the principles of the present application.

### DESCRIPTION

As discussed above, a high voltage battery system generally includes a battery pack assembly that includes a housing that houses one or more battery modules therein. In some instances, impact loads experienced during an impact event can cause undesirable relative movements of components in a battery pack such as the top cover of the battery pack assembly impacting critical components within the battery pack assembly. In some examples, the top cover of the battery pack assembly can deform and impact the battery modules inside the battery pack assembly. In particular, during high speed side pole impact events, it is important to protect the integrity of the high voltage battery to meet various testing standards (for example, FMVSS305), satisfy high voltage isolation and maintain high voltage battery safety.

Accordingly, the high voltage battery assembly according to the present disclosure provides a robust design for protection of the modules within the high voltage battery assembly such as during high speed impact events. In particular, an inside surface of the top cover of the high voltage battery assembly incorporates a plurality of spacers thereon. The spacers are configured to distribute the load onto the upper surface of the modules and therefore reduce the contact force on critical components of the modules such as the cell supervisory circuit. Explained further, direct contact of the cover with the critical components of the modules is reduced in identified areas that include the spacers. The spacers provide a robust design for module protection and high voltage battery safety during high speed impact events. In examples, the spacers are formed of nylon. The spacers at least partially absorb load from the top cover and reduce the load that ultimately is transferred to the battery modules.

The top cover and spacer configuration of the present disclosure provides many advantages over prior art solutions. In particular, some prior art solutions focus on repackaging of the internal components of the battery pack assembly. Unfortunately, this prior art solution is not always desirable as it can affect the number of battery cells that can be packaged and in some cases, may not be possible due to off-the-shelf module sourcing. Any reduction in the amount of batteries can result in sub-optimal performance of the batteries.

In other prior art solutions, increasing of a gap between the battery and the battery case (top cover, etc.) is challenging as it affects the ride height requirement of the vehicle. In other prior art solutions, changing the deformation mode of the body would require up-gauging of parts which affects the weight and/or cost targets for the vehicle as a whole. In this regard, high-voltage batteries are typically common with multiple programs in and additional modifications on battery components such as top covers would sometimes undesirably affect other programs.

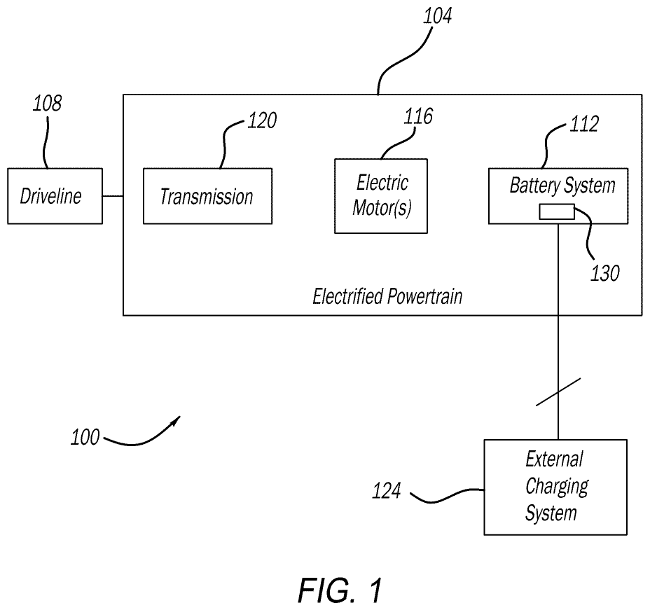

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission 120. The battery system 112 is selectively connectable (e.g., by the driver) to an external charging system 124 (also referred to herein as “charger 124”) for charging of the battery system 112. The battery system 112 includes at least one battery pack assembly 130.

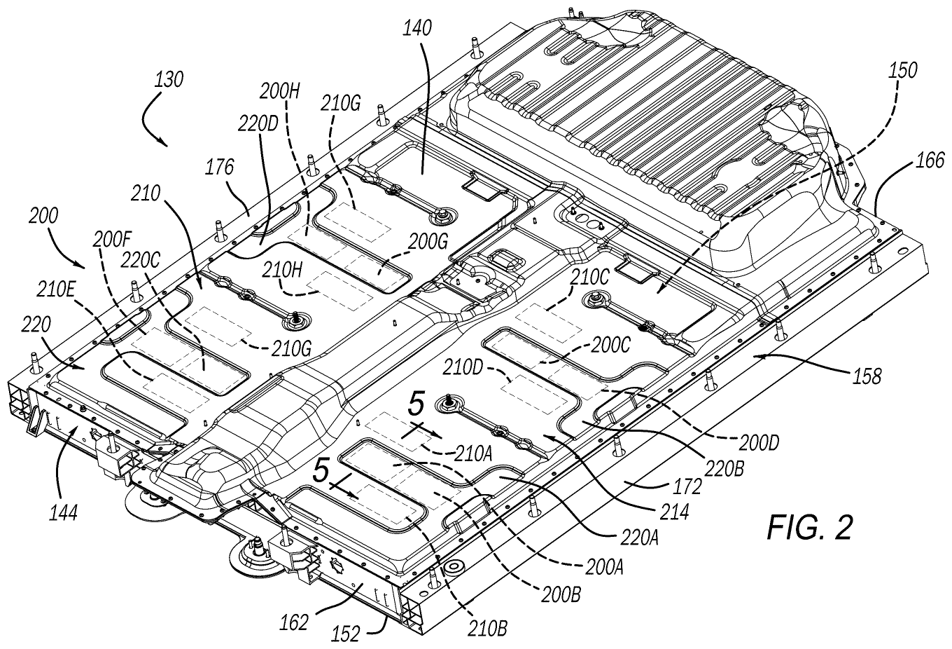

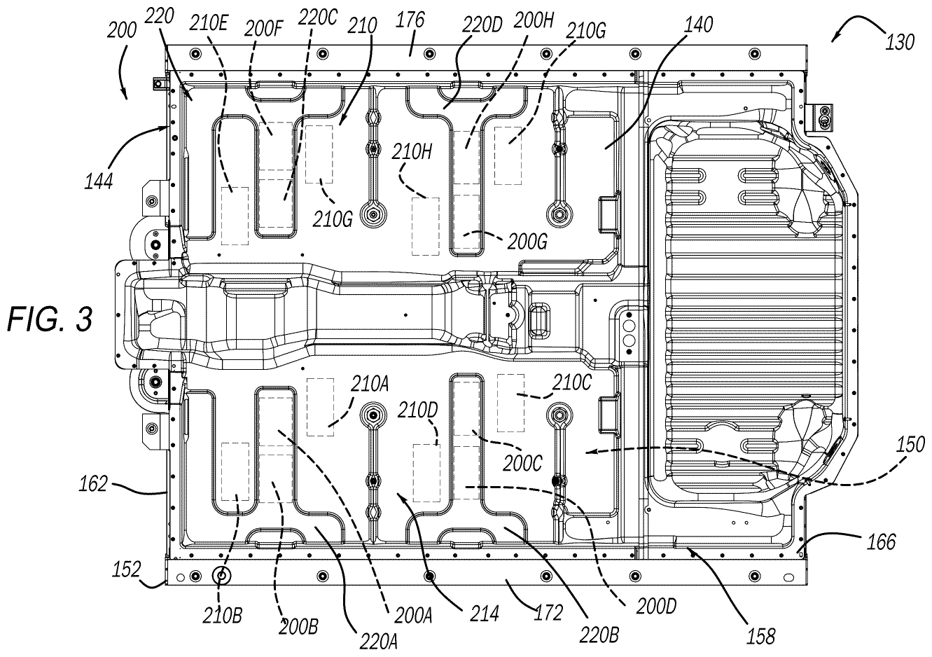

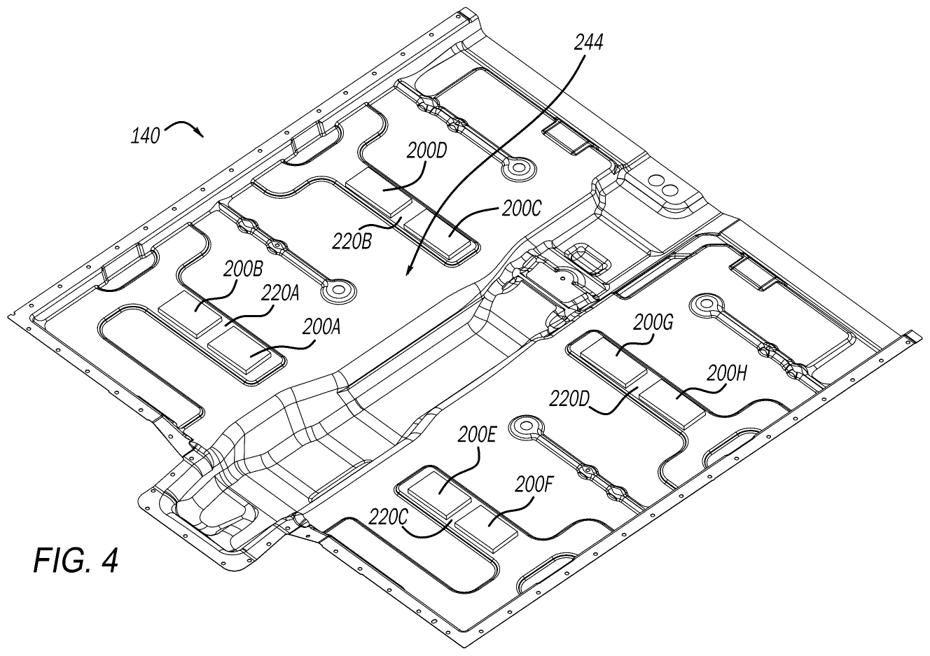

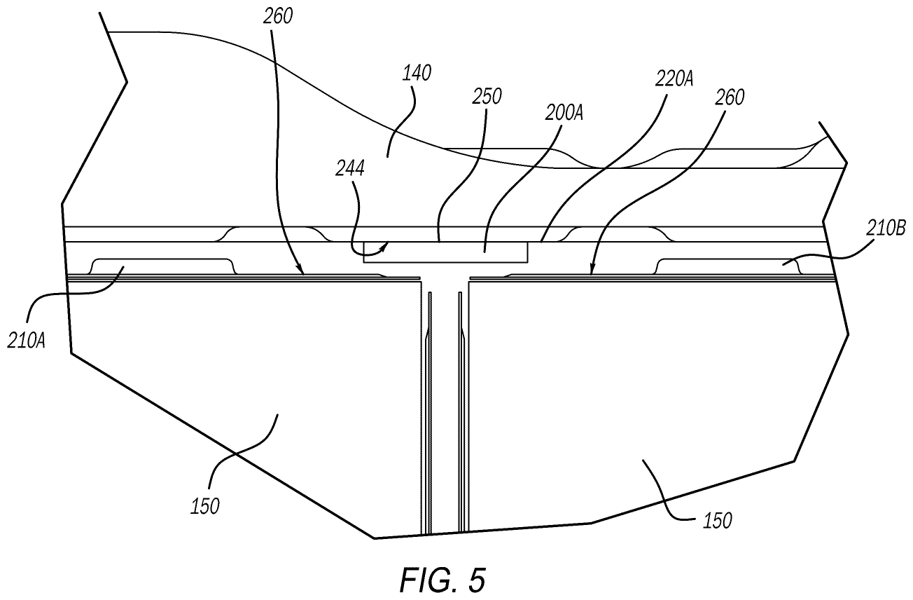

Referring now to FIGS. 2-5, the battery pack assembly 130 according to one example of the present disclosure will be described. The battery pack assembly 130 includes a top cover 140, and a main body assembly 144. The top cover is coupled to the main body assembly 144 in the installed position shown in FIG. 2. A plurality of battery modules 150 (FIG. 5), are housed in the battery pack assembly 130 under the top cover 140. In some examples, the main body assembly 130 further houses a cooling plate 150 and a bottom plate 152. The cooling plate 150 is configured to cool components of the battery pack assembly 130.

The main body assembly 144 of the battery pack assembly 130 according to some implementations of the present application generally includes a structural frame support assembly 158. The structural support frame assembly 158 can include a front beam 162, a rear beam 166, a first side beam 172 and a second side beam 176.

According to the present disclosure, the top cover 140 incorporates a plurality of spacers, collectively identified at reference 200 and individually identified at reference 200A, 200B, 200C, 200D, 200E, 200F, 200G and 200H. In examples, the spacers 200 are arranged generally between a collection of cell supervisory circuits (CSC's), collectively identified at reference 210 and individually identified at reference 210A, 210B, 210C, 210D, 210E, 210F, 210G and 210H.

In the example shown, the top cover 140 generally provides an outermost surface 214 and a plurality of inset portions, collectively identified at reference numeral 220 and individually identified at reference numeral 220A, 220B, 220C and 220D.

With particular reference now to FIG. 5, additional features of the present disclosure will be described. The spacer 200A can be disposed on an inside or interior surface 244 of the top cover 140. The interior surface 244 generally faces the battery modules 150. In examples, the spacer 200A can be adhesively mounted and/or affixed to the inside surface 244 by way of glue 250. Other methods of attachment are contemplated.

As the spacer 200A is provided on the inset 220A of the top cover 140, the spacer 200A is arranged generally proximate to top surfaces 260 of the respective modules 150. In advantages, the spacer 200A (and other spacers 200) can engage the top surface 260 of the respective module 250 reducing occurrence of direct impacting of the top cover 140 with the CSC's 210A, 210 (and other CSC's 210 shown in FIG. 2). In examples, the spacer 220A is vertically aligned with both of the battery modules 150.

It is appreciated that all of the spacers 200 are arranged on the interior surface 244 of the top cover 140 in the same manner for providing an improved distribution of load onto the battery modules 150. The spacer configuration improves load distribution mitigating impact loads realized by the battery modules 150, such as any critical components including the CSC's 210 during high speed impacts. The spacer configuration further does not add significant complexity such as complicated components, welds or adding any meaningful weight to the battery assembly 130. The manufacturing and assembly process is straightforward and simple as it requires affixing the spacers 200 to the inside surface 244, such as by glue.

The module contact force for the battery pack assembly 130 of the present disclosure that incorporates the touch pads or spacer 200 according to principles of the present application is significantly reduced. The battery pack assembly 130 of the present disclosure provides a significant improvement in mitigating forces that are translated from the top cover 140 to the battery modules 150 during a high force impact event.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A battery pack assembly for an electrified vehicle, the battery pack assembly comprising:
a main body assembly that houses a plurality of battery modules therein, the plurality of battery modules having cell supervisory circuits;
a top cover coupled to the main body assembly, the top cover having an interior surface that faces the plurality of battery modules; and
a first spacer disposed on the interior surface of the top cover and occupying a space generally between the top cover and at least one battery module of the plurality of battery modules, the first spacer configured to engage a battery module of the plurality of battery modules during an impact event that deforms the top cover toward the battery modules.

2. The battery pack assembly of claim 1, wherein the top cover comprises an outermost surface and a first inset, wherein the first inset is offset from the outermost surface toward a first battery module of the plurality of battery modules.

3. The battery pack assembly of claim 2, wherein the first spacer is disposed at the first inset.

4. The battery pack assembly of claim 2, wherein the first spacer is vertically aligned with the first battery module and a second battery module of the plurality of battery modules.

5. The battery pack assembly of claim 1, wherein the first spacer is adhesively coupled to the top cover.

6. The battery pack assembly of claim 1, wherein the first spacer is glued to the top cover.

7. The battery pack assembly of claim 1, wherein the first spacer is formed of nylon.

8. The battery pack assembly of claim 4, wherein the cell supervisory circuits comprise a first cell supervisory circuit associated with the first battery module and a second cell supervisory circuit associated with the second battery module.

9. The battery pack assembly of claim 8, wherein the first and second cell supervisory circuits are vertically aligned with the outermost surface of the top cover outside of the first inset.

10. The battery pack assembly of claim 4, further comprising a second spacer disposed on the interior surface of the top cover and occupying a space generally between the top cover and at least one battery module of the plurality of battery modules.

11. The battery pack assembly of claim 10, wherein the first and second spacers are both arranged on the first inset.

12. The battery pack assembly of claim 11, further comprising a third spacer and a fourth spacer disposed on the interior surface of the top cover and occupying a space generally between the top cover and at least one battery module of the plurality of battery modules.

13. The battery pack assembly of claim 10, wherein the third and fourth spacers occupy a second inset provided on the top cover, distinct from the first inset.
